(19) United States
(12) Patent Application Publication
(10) Pub. No.: US 2010/0011143 A1
(43) Pub. Date: Jan. 14, 2010

(54) HDMI extender compatible with high-bandwidth digital content protection

(75) Inventors: Yuh-Chin Chang, Hsinchu (TW); Hui-Ya Chou, Hsinchu (TW); Hsiang-Lin Yeh, Hsinchu (TW)

Correspondence Address: BACON & THOMAS, PLLC, 625 SLATERS LANE, FOURTH FLOOR, ALEXANDRIA, VA, 22314-1176, US

(73) Assignee: GOMAX ELECTRONICS, INC.,, Hsin Chu (TW)

(21) Appl. No.: 12/292,162

(22) Filed: Nov. 13, 2008

(30) Foreign Application Priority Data
Jul. 9, 2008 (TW) 097212123

(51) Int. Cl. G06F 13/00

(52) U.S. Cl. 710/300

(57) ABSTRACT

A high-definition multimedia interface (HDMI) extender compatible with high-bandwidth digital content protection (HDCP) has a data receiver for receiving video/audio data and a data transmitter for transmitting the video/audio data to a display device. An Ethernet cable consisting of eight cores is connected between the data receiver and the data transmitter. When either the video/audio data or the display device complies with the HDCP, a voltage signal with level variation is transmitted between the data receiver and the data transmitter through the Ethernet cable to permit the display device to display the video/audio data.

### BACKGROUND OF THE INVENTION

1. Field of the Invention

The invention relates to a high-definition multimedia interface (HDMI) extender, and more particularly to a HDMI extender that uses a single Ethernet cable to extend signal transmission distance and supports bandwidth digital content protection (HDCP).

2. Description of Related Art

The high-definition multimedia interface (HDMI) is a standard developed to transmit audio/video signals, and allows the video/audio signals to be carried on a single cable for the purpose of simplifying the routing of data wires. The HDMI is widely applied to many electronic products such as TV, DVD player, computers and so forth.

The HDMI supports multiple formats, for example the standard-definition televisions and high-definition television (HDTV). In the aspect of data transmission, the HDMI mainly uses two communications channels. One is the transition minimized differential signaling (TMDS) channel and the other one is the display data channel (DDC).

The HDMI is capable of transmitting high-bandwidth digital content protection (HDCP) data. The HDCP developed by Intel Corporation is a means of data protection to prevent the digital video/audio content from being unauthorized copied or spread. Therefore, any HDCP-compliant video/audio device will verify the validity of the data while transmitting.

However, the specific HDMI cable designated to HDMI data transmission is expensive and has an upper length limit, accordingly increasing the data transmission cost and cable routing complexity between transmitting and receiving sides. To solve the problem, a HDMI signal extender is developed and connected to both a data transmitter and a receiver to lengthen data transmission distance.

The current HDMI extender may use either a single category 5 (Cat 5) cable or two category 5 cables for data transmission. With reference to FIG. 5, the HDMI extender has a data receiver and a data transmitter respectively coupled to a video/audio data source and a display device. A single Cat 5 cable consisting of 8 cores is connected between the data receiver and the data transmitter. Since the 8 cores of the cable are all used to transmit four pairs of TMDS-based differential signals, the verification information necessary for HDCP is omitted and data may be easily copied. In other words, the data transmission does not meet the HDCP standard.

With reference to FIG. 6, the HDMI extender uses two cables to respectively transmit video/audio data and verification information. Although the data transmission has complied with HDCP standard, the increased number of cables remarkably causes higher cost and routing complexity in many applications. For example, the cable routing work will become very difficult in a large exhibition demonstrating fashion multimedia products.

### SUMMARY OF THE INVENTION

The main objective of the present invention is to provide an HDMI extender that uses a single cable to transmit data and is in compliance with HDCP to prevent the video/audio content from being copied.

The high-definition multimedia interface (HDMI) extender compatible with high-bandwidth digital content protection (HDCP) has a data receiver for receiving video/audio data and a data transmitter for transmitting the video/audio data to a display device. An Ethernet cable consisting of eight cores is connected between the data receiver and the data transmitter. When either the video/audio data or the display device complies with the HDCP, a voltage signal with level variation is transmitted between the data receiver and the data transmitter through the Ethernet cable to permit the display device to display the video/audio data.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a HDMI extender in accordance with the present invention;

FIG. 2 is a block diagram of a first embodiment of the HDMI extender in accordance with the present invention;

FIG. 3A is a schematic view of a high-to-low voltage signal in accordance with the present invention;

FIG. 3B is a schematic view of a low-to-high voltage signal in accordance with the present invention;

FIG. 4A is a schematic view of a high-to-low voltage signal output from a driver in accordance with the present invention;

FIG. 4B is a schematic view of a low-to-high voltage signal output from a driver in accordance with the present invention;

FIG. 5 is a block diagram of a conventional HDMI extender using single cable for data transmission; and

FIG. 6 is a block diagram of a conventional HDMI extender using two cables for data transmission.

### DETAILED DESCRIPTION OF THE PREFERRED EMBODIMENT

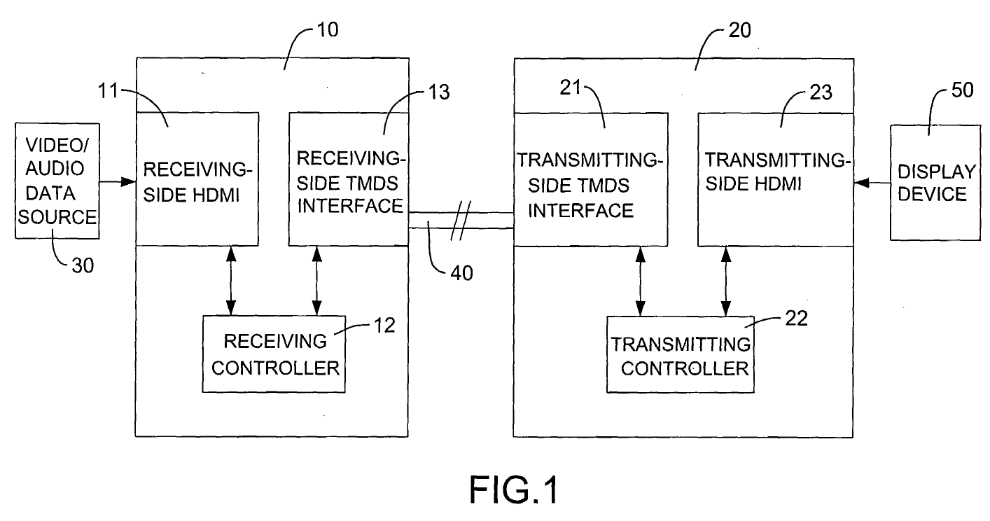

With reference to FIG. 1, a high-definition multimedia interface (HDMI) extender in accordance with the present invention comprises a data receiver (10) and a data transmitter (20).

The data receiver (10) has a receiving-side high-definition multimedia interface (HDMI) (11), a receiving controller (12) and a receiving-side transition minimized differential signaling (TMDS) interface (13).

The receiving-side HDMI (11) receives video/audio data from an external video/audio source (30) such as a DVD player, a game console (PS3, Xbox) and etc.

The receiving controller (12) connects to the receiving-side HDMI (11) and the receiving-side TMDS interface (13) and determines whether the received video/audio data are protected by high-bandwidth digital content protection (HDCP) based on received information through two pins SCL and SDA of the DDC channel of the receiving-side HDMI (11).

The receiving-side TMDS interface (13) for connecting to an Ethernet cable (40) outputs the video/audio data to the data transmitter (20). The Ethernet cable (40) may be, but not limited to, a category 5 (Cat 5) cable, a category 6 (Cat 6) cable or a category 7 (Cat 7) cable consisting of 8 cores. When the receiving controller (12) recognizes that the video/audio data support the HDCP, a voltage signal with level variation is applied to any one of the 8 cores of the Ethernet cable (40). The voltage signal may be either a high-to-low level signal or a low-to-high level signal.

The data transmitter (20) comprises a transmitting-side TMDS interface (21), a transmitting controller (22) and a transmitting-side HDMI (23).

The transmitting-side TMDS interface (21) connects to the Ethernet cable (40) to receive the video/audio data.

The transmitting controller (22) connects to the transmitting-side TMDS interface (21) and the transmitting-side HDMI (23) and determines whether the video/audio data support the HDCP.

The transmitting-side HDMI (23) is to be connected to a display device (50). If the video/audio data supports the HDCP, the transmitting controller (22) then checks whether the display device (50) is an HDCP-compliant device. If the display device (50) complies with the HDCP, the video/audio data can be transmitted to the display device (50). Otherwise, the video/audio data are prohibited from transmitting to the display device (50).

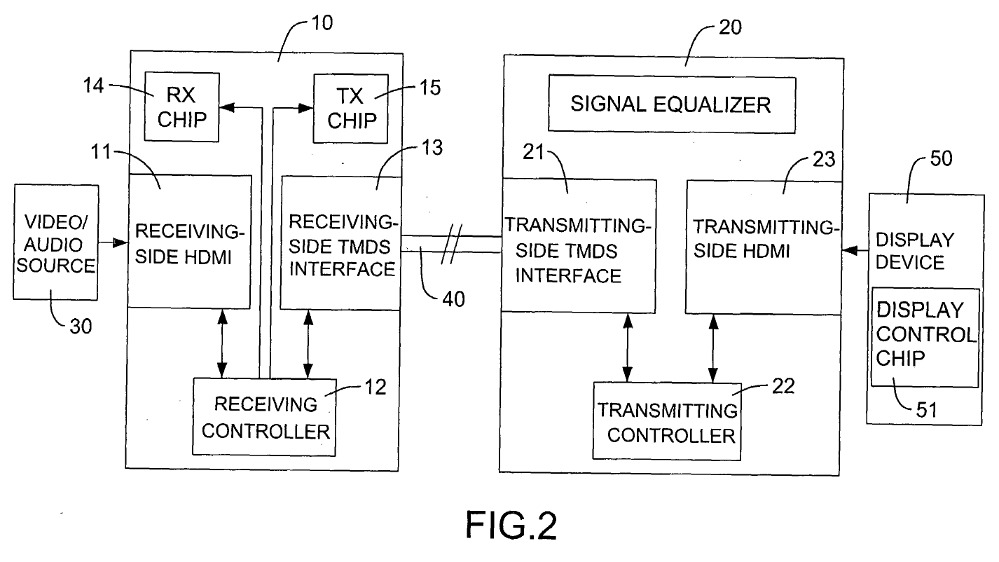

With reference to FIG. 2, in the first embodiment, the receiving controller (12) of the data receiver (10) connects to a receiving chip (14) and a transmitting chip (15). Since any HDCP-compliant video/audio source (30) will communicate with the receiving chip (14), the receiving controller (12) is able to determine whether the received video/audio data supports the HDCP through the receiving chip (14). When the receiving chip (14) completes the HDCP verification, the transmitting chip (15) allows the receiving-side TMDS interface (13) to output the video/audio data. Further, at least one pin of the receiving-side TMDS interface (13) is designated to transmit the voltage signal to the data transmitter (20) through the Ethernet cable (40). Therefore, the data transmitter (20) is notified that the video/audio data are in compliance with the HDCP.

If the display device (50) is a HDCP-compliant HDMI display device, the transmitting controller (22) can communicate with a display control chip (51) of the display device (50) via two pins SCL and SDA of the DDC channel of the transmitting-side HDMI (23) and obtain response information from the display device (50). For any HDCP-compliant HDMI display device, the two pins SCL and SDA provide response and identification information. Therefore, based on the detection of the voltage signal from the data receiver (10) and response information from the display device (50), the HDMI extender can determine if the data can be output to the display device (50).

For non-HDCP-compliant display devices, the HDMI extender only transmits the unprotected video/audio data. Further, the data transmitter (20) may further comprise a signal equalizer to improve the ability of receiving video/audio data from the data receiver (10).

In the foregoing first embodiment, the data receiver (10) directly checks the video/audio data output from the video/audio source (30) and may provide a voltage signal to the data transmitter (20) based on the checked result. Different from the first embodiment, the data transmitter (20) in accordance with the second embodiment firstly checks whether the display device (50) is a HDCP-compliant device. If the display device (50) complies with the HDCP, the data transmitter (20) outputs a voltage signal to notify the data receiver (10). The data receiver (10) then determines whether the video/audio data is protected and can be transmitted to the data transmitter (20).

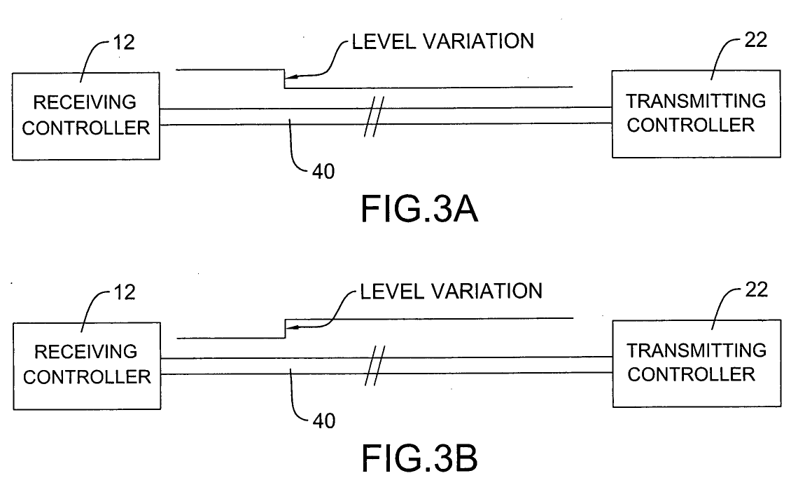

With reference to FIGS. 3A and 3B, the voltage signal may be either a high-to-low level signal or a low-to-high signal. The voltage level variation can be accomplished by changing the voltage level in any pin of the data transmitter (20) or the data receiver (10) so that the corresponding data receiver (10) and the data transmitter (20) can recognize such a voltage change.

The voltage signal with level variations is preferably transmitted and checked in an initial stage that the HDMI extender has connected to the related devices, but the devices do not start to transmit the video/audio data yet.

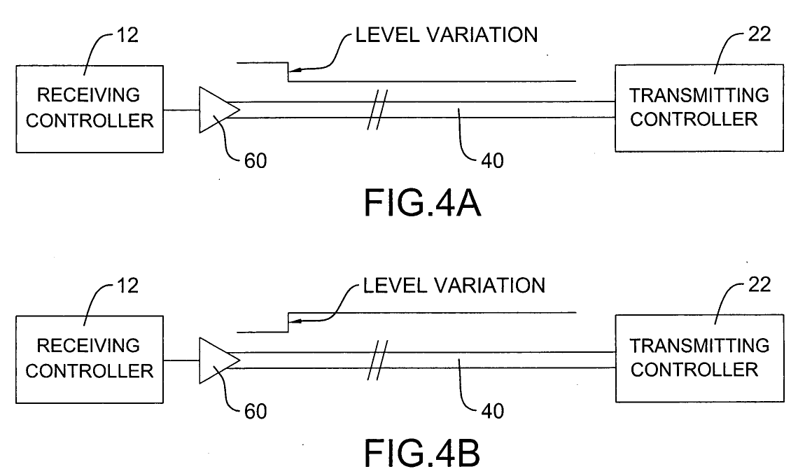

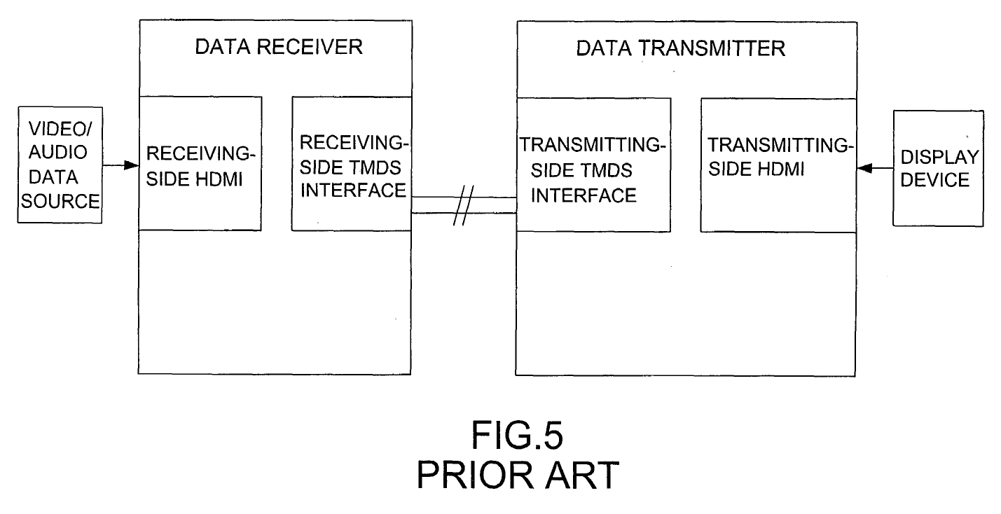

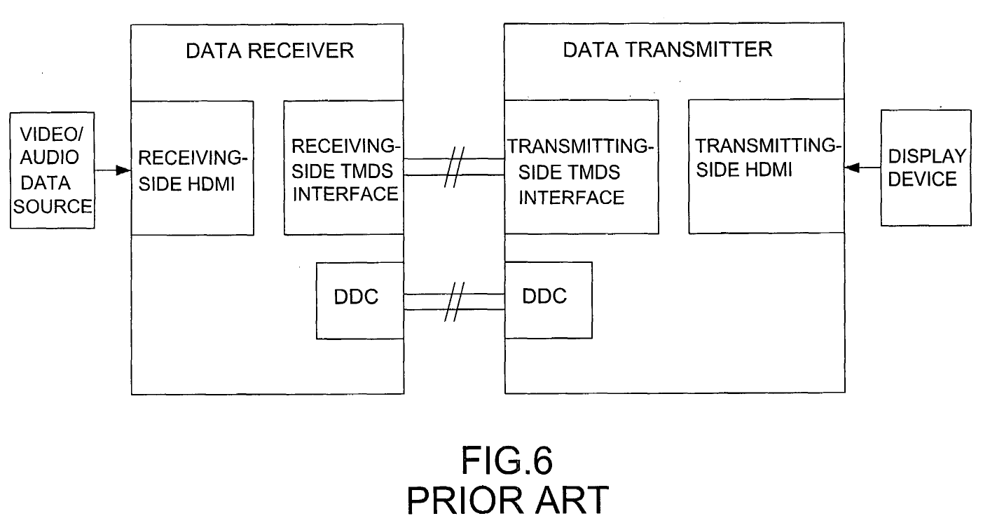

With reference to FIGS. 4A and 4B, how far the signal can be effectively transmitted mostly depends on the quality of the cable (40). For applications of long-distance transmission, a driver (60) may be added and connected to the output of the receiving controller (12) to mitigate the extent of signal attenuation so that the data can be transmitted farther.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A HDMI extender compatible with HDCP, comprising:
a data receiver having
a receiving-side high-definition multimedia interface (HDMI) for receiving video/audio data from an external video/audio source;
a receiving controller connected to the receiving-side HDMI and determining whether the video/audio data is in compliance with high-bandwidth digital content protection (HDCP); and
a receiving-side transition minimized differential signaling (TMDS) interface connected to the receiving controller for outputting the video/audio data through an Ethernet cable consisting of eight cores;
a data transmitter having
a transmitting-side transition minimized differential signaling (TMDS) interface connected to the data transmission for receiving the video/audio data;
a transmitting-side high-definition multimedia interface (HDMI) for connecting to a display device; and
a transmitting controller connected to the transmitting-side HDMI and the transmitting-side TMDS interface, and determining whether the display device is in compliance with the HDCP;
a voltage signal with level variation being transmitted between the receiving-side TMDS interface and the transmitting-side TMDS interface through a core of the Ethernet cable when either the video/audio data or the display device is in compliance with the HDCP.

2. The HDMI extender as claimed in claim 1, wherein the voltage signal is output from any pin of the receiving-side TMDS interface to the data transmitter when the receiving controller determines that the video/audio data is in compliance with the HDCP.

3. The HDMI extender as claimed in claim 1, wherein the voltage signal is output from any pin of the transmitting-side TMDS interface to the data receiver when the transmitting controller determines that the display device is in compliance with the HDCP.

4. The HDMI extender as claimed in claim 1, wherein the receiving controller determines whether the video/audio data is in compliance with the HDCP based on information detected from a SCL pin and a SDA pin of the receiving-side TMDS interface.

5. The HDMI extender as claimed in claim 2, wherein the receiving controller determines whether the video/audio data is in compliance with the HDCP based on information detected from a SCL pin and a SDA pin of the receiving-side TMDS interface.

6. The HDMI extender as claimed in claim 3, wherein the receiving controller determines whether the video/audio data is in compliance with the HDCP based on information detected from a SCL pin and a SDA pin of the receiving-side TMDS interface.

7. The HDMI extender as claimed in claim 2, wherein the voltage signal is transmitted to the core of the Ethernet cable through a driver.

8. The HDMI extender as claimed in claim 3, wherein the voltage signal is transmitted to the core of the Ethernet cable through a driver.
